(19) United States
(12) Patent Application Publication
(10) Pub. No.: US 2008/0261046 A1
(43) Pub. Date: Oct. 23, 2008

(54) Method For Producing Molded Bodies From Thermoplastic Material

(75) Inventor: Daniel Husler, Zurich (CH)

Correspondence Address: RANKIN, HILL & CLARK LLP, 38210 Glenn Avenue, WILLOUGHBY, OH, 44094-7808, US

(73) Assignee: PLASTXFORM AG, Fällanden (CH)

(21) Appl. No.: 10/599,087

(22) PCT Filed: Mar. 29, 2005
(86) PCT No.: PCT/CH2005/000180

§ 371 Date: Jun. 26, 2008

(30) Foreign Application Priority Data
Mar. 30, 2004 (CH) 544/04

(51) Int. Cl. B32B 9/04

(52) U.S. Cl. 428/411.1; 264/101; 425/405.2

(57) ABSTRACT

The invention makes possible the one-step production of molded bodies (1) of different types out of thermoplastic material with or without reinforcing fibers. For this purpose, a tool with a lower and an upper shell mold (10a, 10b), which form defined surfaces on both sides, is utilized. The shell molds have thin walls and are made out of metal and comprise a centered portion on both shell molds, a displacement compensating, air-tight edge seal (16) and tempering means (13) for the controlled heating and cooling on both shell molds. For production, thermoplastic material (2) with reinforcing fibers (3) is inserted into the shell molds in a locally defined manner, the shell molds are subsequently evacuated (p1) and in doing so pressed together (ds), then heated up to above the melting point and maintained at a temperature (Ts) for the consolidation and flowing of the thermoplastic material under pressure (dp).

### BACKGROUND OF THE INVENTION

1. Field of the Invention

The invention is related to a method for producing molded bodies out of thermoplastic material with or without reinforcing fibers in a one-step production process and an installation for the production.

2. Description of Related Art

For the production of structural molded bodies, e.g., thermal molding is utilized, which makes short cycle times for large series possible. It does, however, require very high investments for large presses as well as expensive and elaborate tools, so these methods are much too expensive for medium-sized and smaller series. In addition to this, the structure and the shaping of molded bodies of this kind are very limited.

Vacuum molding, e.g., according to EP 0 893 235 A3, represents a much less expensive method, which, however, necessitates very long cycle times of, e.g., 40 minutes and which therefore is only utilizable for small series. In the case of vacuum molding, thermoplastic material with fiber reinforcements is placed on a shaped substrate, covered with an air-tight diaphragm and heated up in an oven under vacuum, melted together and consolidated and subsequently cooled down again. For this purpose, venting layers on both sides and separating foils are required as consumable material, and finishing work is also necessary. The shaping here is limited in addition and it is only possible to produce a defined shaped surface on one side.

### BRIEF SUMMARY OF THE INVENTION

It is therefore the objective of the invention presented here to overcome the disadvantages of methods according to the state of the art and to create a one-step method for the inexpensive, automatable series production of molded bodies of high quality with short cycle times and with improved characteristics and with it to produce molded bodies with a structural construction, with a broad spectrum of possibilities with respect to structure, shaping and design and with defined shaped surfaces on both sides and in particular also with pore-free visible surfaces on both sides.

This objective is achieved according to the invention by a method for the production of molded bodies and by an installation for the production of molded bodies. The method is suitable both for simpler non-reinforced molded bodies with visible surfaces on both sides as well as, above all, for structural components with fiber reinforcement, which are capable of satisfying high mechanical demands.

The dependent claims are related to advantageous further developments of the invention with particular advantages with respect to optimum process control, structure, shaping, surface formation and design of the molded bodies as well as to their mechanical characteristics.

### BRIEF DESCRIPTION OF THE DRAWINGS

In the following, the invention is further explained on the basis of examples of embodiments and Figures, which illustrate:

FIG. 1 on a device according to the invention with shell molds on both sides and tempering means the method for the production of thermoplastic molded bodies reinforced with fibers,

FIG. 2 a course of the temperature over time on the shell molds,

FIG. 3 a course of the differential pressure exerted on the shell molds over time,

FIG. 4 a course of the resulting compression displacement over time,

FIG. 5 a course of the differential pressure with an additional external pressure over time,

FIG. 6 a further example of a course over time of the temperature,

FIG. 7 an example of tempering means with channels and heating wires integrated into the shell molds,

FIG. 8, 9 examples of centerings and retention zones,

FIG. 10, 11 examples of edge seals,

FIG. 12 shell molds for a recumbent shell,

FIG. 13 shell molds in horizontal projection with different tempering zones,

FIG. 14a-d illustrate the steps of the method,

FIG. 15 a typical structure of a layer,

FIG. 16a, b examples of shapings of the shell molds,

FIG. 17a a molded body with inserts,

FIG. 17b a molded body with elastic zones and with a hollow body,

FIG. 18 an installation according to the invention with assigned stations,

FIG. 19 two-part, separatable shell molds with an edge part and a mold part,

FIG. 20 a shell mold with differing zones,

FIG. 21 a shell mold with an integrated gas cushion.

### DETAILED DESCRIPTION OF THE INVENTION

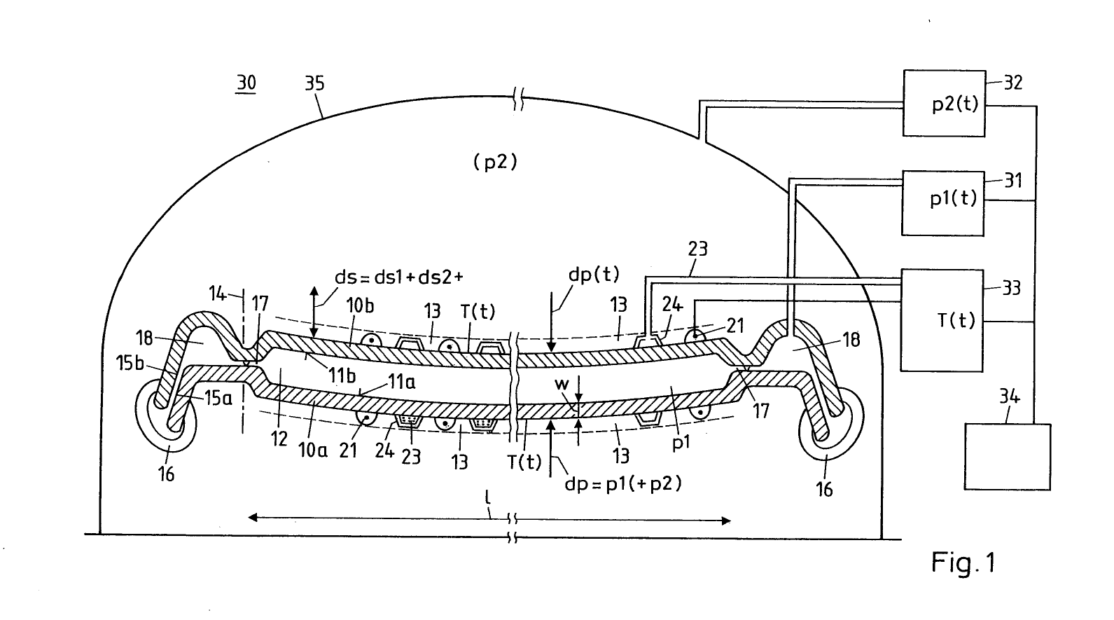

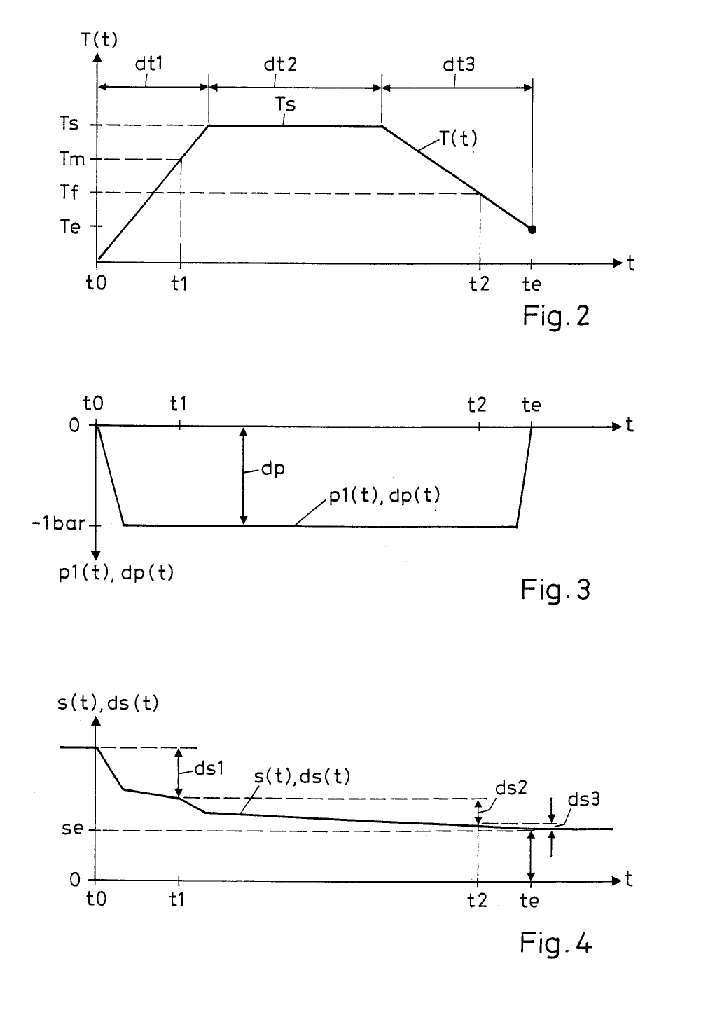

The method according to the invention for the production of molded bodies out of fiber-reinforced (or also out of non-reinforced) thermoplastic material in a one-step manufacturing process is illustrated with the installation 30 of FIG. 1 in conjunction with the FIGS. 2-6. FIG. 1 depicts a tool with a lower and an upper shell mold 10a, 10b, which form a mold cavity 12 with defined surfaces 11a, 11b on both sides. These shell molds have thin walls and are produced out of metal and they comprise a centered portion 15a, 15b of the two shell molds, a displacement compensating, air-tight edge seal 16 between the two shell molds and tempering means 13 for the controlled heating and cooling on both shell molds. The tempering means 13 with a good heat transmission to the shell molds here consist of heating wires 21 and cooling channels 24 with a cooling medium 23. The shell molds, in addition, contain a retention zone 17 and a vacuum channel 18 at the edge as well as a vacuum device 31 for the evacuation of the mold cavity, a tempering device 33 and a control system 34. Vacuum connections are also able to be attached at suitable points within the shell molds. With a compressed air device 32 it is possible to apply an additional external pressure p2 to the shell molds 10a, 10b in a pressure chamber 35.

For the production of the molded bodies, a thermoplastic material 2 with or without reinforcing fibers 3 is inserted into a shell mold in a locally defined manner, thereupon the shell molds are closed and evacuated with the pressure p1 and in doing so compressed, as a result of which a reduction ds1 of the distance between the shell molds takes place. Subsequently the shell molds with the tempering means 13 are heated up to beyond the melting point Tm of the thermoplastic material 2 and maintained at a temperature Ts for the consolidation and melting of the thermoplastic material under the pressure dp acting on the shell molds, wherein a further pressing together of the shell molds by a compression displacement ds2 takes place up to the contour filling flowing out. Following this, a defined cooling down under pressure up to the complete solidification of the inserted material takes place, i.e., to below the solidifying temperature Tf, whereupon the shell molds are opened and the formed molded body 1 is removed.

The dimensioning of the metal shell molds 10 with a relatively small wall thickness w is selected in such a manner,

that there is a sufficient mechanical strength for carrying out the process,

that the shell molds are dimensionally stable, i.e., practically rigid in a tangential direction, so that a defined surface shape is produced,

and nonetheless sufficiently thin, so that the shell molds are slightly elastically flexible in a vertical direction dp, so that differences in thickness are able to be compensated for to a limited extent,

and that with this a very good and in the tangential direction balanced thermal conduction from the tempering means 13 through the metallic shell mold to the inserted material takes place.

For this purpose, the dimensioning, for example, may amount to:

a wall thickness w of, e.g., 1-5 mm, in preference usually 1-3 mm,

with a length, resp., longitudinal expanse 1 of the shell mold of, e.g., 10-100 cm,

and with a ratio of wall thickness to length w/l, for example, in the order of magnitude of 1%.

With the double sided thin metallic shell molds 10a, 10b according to the invention with tempering means 13 the following is achieved:

high heating—and cooling powers directly on the shell molds with a high thermal conductivity, this results in,

shorter cycle times with an optimum, rapid, dynamic controlling of the temperature T(t),

completely defined surface shapes on both sides,

through the directed compression force dp, which is applied to the shell molds, a lateral flowing out of thermoplastic material up to the complete filling out of complex mold cavities is achieved

and, because of a slight elastic flexibility of the thin shell molds, it is possible during the cooling down to re-press differences in layer thickness within certain areas during the cooling down and therefore also to compact them better.

With this, it is possible to economically produce molded bodies of a high quality in a single step practically in their final shape. A subsequent cutting of contours is eliminated.

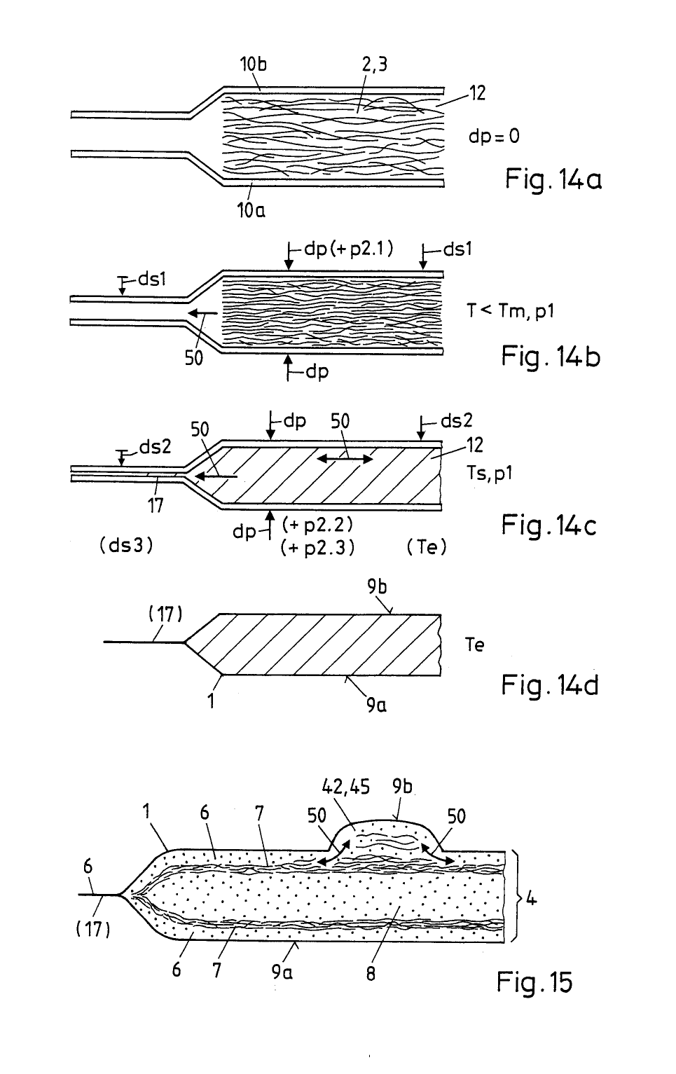

FIGS. 2-6 illustrate the steps of the method according to the invention: the controlling of temperature, pressure over time and the compression effected by this up to the complete flowing out of the cavity and the compaction of the molded body (also refer to FIG. 14a-d).

FIG. 2 illustrates the controlled course of the temperature at the shell molds 10a, 10b in function of the time T(t) with three time phases: heating-up in a time dt1, consolidation and flowing out into the mold in a time dt2 and cooling down in a time dt3. Typical times are, e.g.:

dt1 = 3 min. (2-5 min.)
dt2 = 2 min. (1-3 min.)
dt3 = 3 min. (2-4 min.)

The duration of a cycle amounts to, in total, e.g., 8 min. (5-12 min.).

The heating-up takes place relatively rapidly (thanks to tempering means directly attached to the shell molds with an optimum heat transmission to the inserted material) to above the melting point Tm of the thermoplastic material, which is reached after a time t1, and onwards to an adjustable optimum flowing temperature Ts (in correspondence with the inserted material and the required shaping) for the optimum consolidation and mold filling-out. Subsequently a controlled cooling down takes place up to the complete solidification of the molded body at a solidifying temperature Tf at the time t2 (Tf in most cases is below Tm) and to the unmolding at a time te with an unmolding temperature Te which is below Tf.

FIG. 3 illustrates the course of the pressure in function of the time p(t), resp., the differential pressure dp(t) applied to the shell molds. The vacuum, resp., the under-pressure p1 is applied rapidly and maintained until shortly before the unmolding (te). In preference an as complete as possible evacuation with p1=−1 bar takes place, so that no air inclusions and residues of gas are present in the mold cavity anymore. (With a residual vacuum pressure of below 100 mbar, e.g., in the order of magnitude of 1 mbar.) For many applications an evacuation with the under-pressure p1 as pressure difference dp is sufficient, i.e., no additional external pressure p2 is necessary.

FIG. 4 illustrates the resulting corresponding compression displacement s(t) with several different stages ds1, ds2, ds3 of the compressing action. Until the melting point Tm is reached at the time t1, the still solid material is compressed with a compression displacement ds1. Subsequently, a further compression displacement ds2 takes place corresponding to the consolidation and flowing of the thermoplastic material up to the complete filling of the contour. During the cooling down, a contraction of the material takes place. In doing so, as a result of the pressure difference dp, the molded body under creation is compacted, resp., pressed together further, this with a further compression displacement ds3.

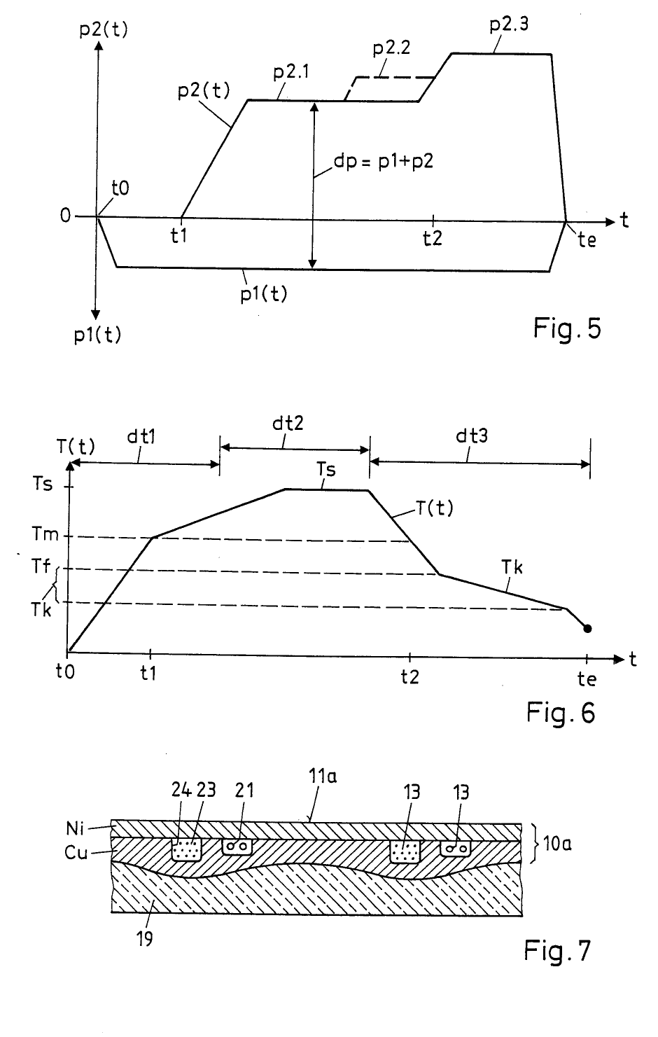

FIG. 5 illustrates the course of the pressure dp(t) in function of the time, when in addition to the vacuum pressure p1(t) an external pressure p2(t) is applied to the shell molds and with this the pressure difference dp(t)=p1(t)+p2(t) is capable of being significantly increased, in order to on the one hand achieve a more rapid consolidation and flowing out and also in order to produce an even stronger compacting (p2.3) during the cooling down. For the optimum running of these processes, it is also possible to increase the external pressure p2(t), e.g., in steps to: p2.1, p2.2, p2.3. With this, on the one hand it is possible to reduce the cycle times and on the other hand to further improve the mechanical characteristics and the compact shaping of particularly demanding molded bodies and also to either prevent or reduce any distortion.

FIG. 6 illustrates a further example of a controlled, dynamic temperature control T(t) (dependent on the type and on the composition of the inserted material). During the heating up, here the temperature T(t) above the melting point Tm is slowly increased further up to the temperature Ts, in order to achieve a more balanced initial flowing out. The cooling down does not take place in a linear manner, but is slowed down within a temperature range, in which material transformations occur, in particular in a crystallization temperature range Tk in the case of partially crystalline thermoplastic materials and with this the crystallization and the resulting strength of the molded body are increased. It is also possible that the controlled control of the temperature T(t) is locally differing. In the case of shapes such as thicker areas and ribs for the prevention of distortion and for better compaction locally, a stronger cooling power can be provided, in order for the complete molded body to be cooled down regularly. These temperatures, for example, for polypropylene as thermoplastic material may amount to: Tm=170° C., Ts=200° C., Tf=130° C. and Tk=130 up to 80° C.

FIG. 7 illustrates further advantageous shapings of the tempering means 13 on the shell molds 10. It is important that for the rapid and uniform, homogeneous heating up and cooling down of the inserted material from the tempering means 13 through the shell molds, a good heat transmission with a good thermal conductivity in the shell molds is achieved. For this purpose, thin metallic shell molds 10 are utilized, which can be manufactured out of metal in different ways, e.g., out of deep-drawn sheet metal (also out of aluminium). They also are capable of being assembled out of several parts (FIG. 20). Particularly advantageous are galvanic layers, which in preference may consist of nickel (Ni) and copper (Cu).

As means of tempering advantageously it is also possible to utilize a fluid, in particular a liquid medium 23, which circulates in channels 24 attached to the shell molds. A liquid medium or fluid is also able to be utilized both solely as cooling medium (e.g., most easily with water) or also as cooling medium and as heating medium. As heating medium and as cooling medium for higher temperatures, it is possible to utilize temperature-resistant oils. A particularly suitable cooling medium for higher temperatures may consist of a mixture of water and air.

As electrically very well controllable tempering means it is also possible to utilize insulated electric heating wires 21, which are attached to the shell molds. In the example of FIG. 7, the tempering means 13, here as channels 24 and as integrated electric heating wires 21, are directly integrated into the shell molds 10, e.g., in the galvanic layers. This results in an economic manufacture and in particularly favorable thermal characteristics. Above these tempering means it is also possible to arrange a thermal insulation layer 19 (e.g., glass wool). The tempering means 13, e.g., can also be applied to the shell molds as plane layers or tapes, as heating pads and as cooling pads. With these tempering means 13 it is possible to achieve very good cooling—and heating performances.

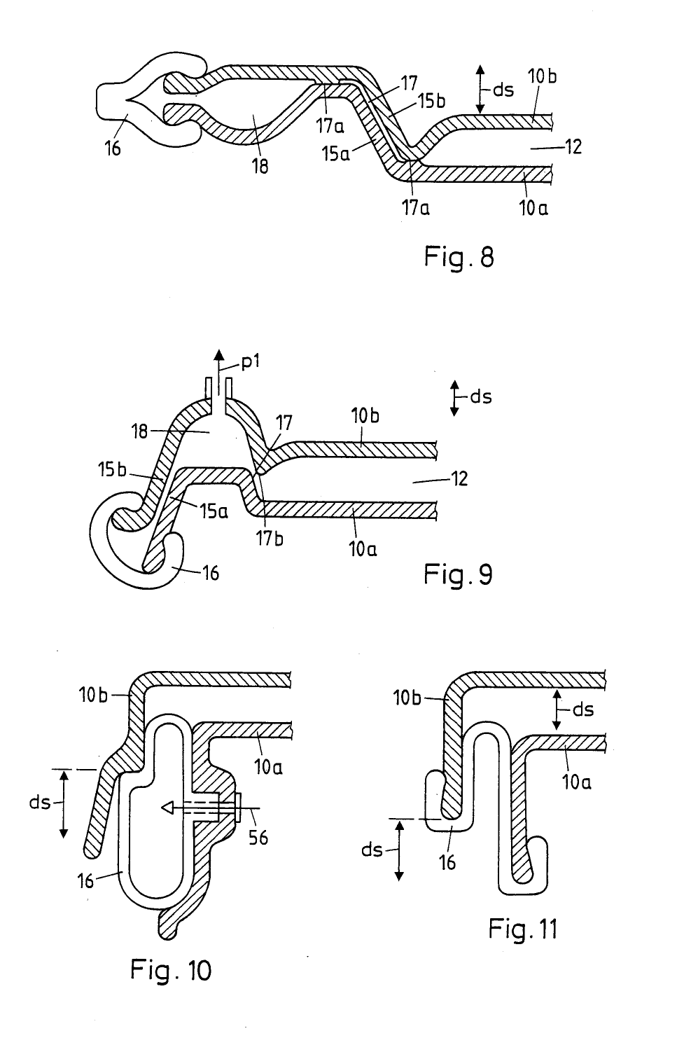

FIGS. 8 and 9 illustrate examples of shapings of edge zones of the shell molds 10a, 10b, which, matched to one another, form vacuum channels 18, centering portions 15 and retention zones 17. The vacuum channels 18 are conducted around the shell molds at their edge. The centering portions 15a, 15b on the two shell molds when coming together guide these in such a manner that the final shapes of the two surfaces of the resulting molded body are positioned accurately relative to one another. On the edge of the mold cavity 12 retention zones, resp., retention means 17 for the molten thermoplastic material are formed, so that during the flowing out the mold cavity is completely filled with thermoplastic material right up to the retention zone, and then here stopped to such an extent, that the applied uniform pressure dp on the whole shell molds 10 is maintained and that nonetheless no further material emerges beyond the retention zones anymore. This retention zone in the example of FIG. 8 comprises a very thin mold gap 17 with a distance of, e.g., solely 0.1 to 0.5 mm in case of mold closure and with contact points 17a, which are completely closed (zero pressing).

The example of FIG. 9 illustrates a plunging edge 17b as retention zone 17, which in case of mold closure of the two shell molds also prevents the outflow of further thermoplastic material.

FIGS. 10 and 11 illustrate examples of displacement compensating edge seals 16, which assure an air-tight sealing during the complete course of the process, so that the compression displacements ds are compensated. FIG. 10 illustrates an example of a hollow profile seal, which here, in addition, is capable of being inflated 56 (with a suitable pressure) and which in principle operates as a hollow profile rolling bellows seal.

FIG. 11 illustrates an example of a simple rolling bellows seal, which connects the edges of the two shell molds 10a, 10b together and seals them air-tight.

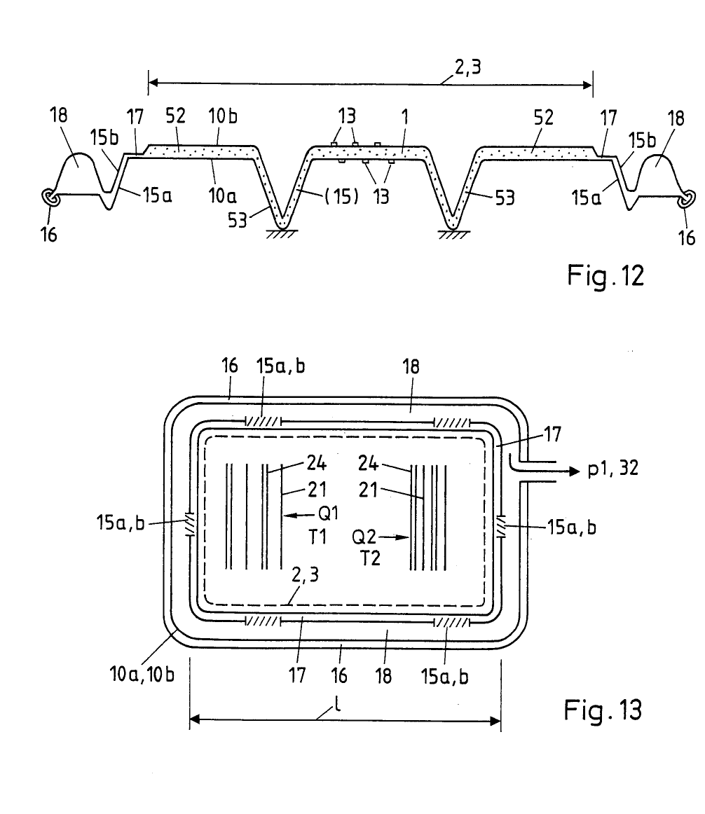

FIG. 12 illustrates a cross section through the shell molds 10a, 10b for a recumbent shell 52 as molded body 1, in the case of which two crimps, resp., supporting skids 53 serve as supports for the recumbent shell. These supporting skids 53 therefore locally comprise a significantly higher proportion of fibers as reinforcement than the other areas of the recumbent shell 52. Through the shaping of the supporting skids 53 it is also possible to achieve a centering action 15.

FIG. 13 illustrates shell molds 10a, 10b in horizontal projection, wherein here the centering portions 15a, 15b on the shell molds are only developed at individual points. The retention zones 17 (as well as the edge seal 16 and the vacuum channel 18) in contrast extend around the complete shell molds at their edge. This example also illustrates a locally differing tempering: In regions or zones, in which a stronger tempering Q2, T2 is to take place, it is also possible, e.g., that the distances between the individual heating wires 21 or cooling channels 24 is selected as smaller than in the regions with lesser tempering Q1, T1. Differing temperings are capable of being achieved by differing heating—and cooling capacities (Q1, Q2) or by differing temperatures (T1, T2), e.g., by differing heating capacities of heating wires 21 or by differing temperatures and flow rates of heating—, resp., cooling media 23. As is illustrated in FIG. 20, it is also possible to locally vary the thermal contact between the tempering means and the shell molds. Thus, for example, retention zones 17 are able to be more strongly cooled and with this the ability of the thermoplastic material to flow is reduced and the further outflow prevented.

FIGS. 14a-14d, in conjunction with the FIG. 2-6, further illustrate the steps of the method. FIG. 14a illustrates the thermoplastic material 2 with reinforcing fibers 3 inserted in cold condition and locally positioned true to form. FIG. 14b illustrates the material compacted by the evacuation, resp., by the directed pressure dp acting on the whole shell molds, which has been pressed together by a compression displacement ds1. FIG. 14c illustrates the flowing out (50) of the thermoplastic materials with a complete filling out of the mold cavity 12 right up to the retention zone 17 with a further compression displacement ds2. Subsequently the cooling down and the post-consolidation and further compression take place with a possible further compression displacement ds3. In doing so, it is possible if so required to apply an external pressure p2 with pressure levels p2.1, p2.2, p2.3 (refer to FIG. 5).

FIG. 14d illustrates the resulting molded body 1 with defined visible surfaces 9a, 9b formed on both sides and with a very thin ridge on the retention zone 17 which is capable of being removed very easily. With this, it is possible to produce molded bodies with a perfect final shape practically without any waste in a single step and relatively rapidly and without any finishing work.

With the method according to the invention, it is possible to introduce different types of materials into the shell mold simultaneously in a cold condition and locally differing materials with differing characteristics and shapes (such as fiber content, flowability, rigidity and types of material) can be inserted into the shell molds in defined positions. As a result, it is possible to locally design the structure of the layers optimally and with a much broader spectrum of possibilities than up until now in correspondence with the most diverse requirements with respect to mechanical characteristics, shaping and the design of visible surfaces on both sides, which are capable of being produced in a simple manner in a one-step process.

The materials introduced into the shell molds, thermoplastic material 2 and reinforcing fibers 3, are able to be utilized in different forms: thermoplastic materials as flowing material in the form of foils, yarns, granulates or powders and fiber reinforcements as woven fiber, laid fibers, fiber fleeces, hybrid yarns and also as semi-finished products. Suitable thermoplastic materials may be, e.g., polypropylene PP, polyamide PA, polyethylene-terephtalate PET, polybutylene-terephtalate PBT, polycarbonate PC, etc. and as reinforcing fibers: glass, carbon or aramide.

FIG. 15 illustrates a typical multi-layer structure 4 for a structural—and molded body 1 reinforced with fibers with external covering layers 6, which also form molded layers, underneath with an upper and a lower structural layer reinforced with fibers 7 and a middle core layer 8, which forms an inner molded layer. The molded layers 6 and 8 in doing so comprise a flowability and dimensioning corresponding to the required shaping. As covering layers, it is also possible, e.g., to utilize coats of color, which extend into the retention zone 17 up to the end of the molded body, while structural layers 7 may end before the retention zone (17) and with this it is not necessary to cut off any layers of fiber after the unmolding. FIG. 15 as an example also illustrates a geometrical shaping 42 with a greater wall thickness 45, which is filled and flowed out with a suitable material inlaid.

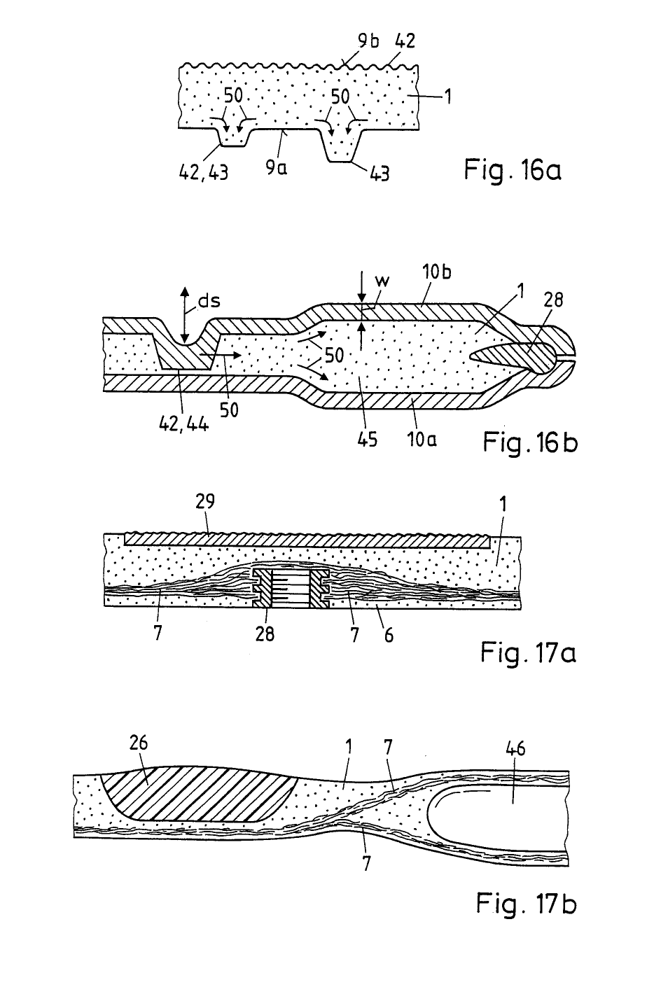

FIGS. 16a, b illustrate shell molds 10a, 10b, resp., resulting molded bodies 1, which comprise different geometrical shapings 42. FIG. 16a on the upper surface 9b illustrates a shaping in the form of a structured surface, e.g., with a grain pattern as visible surface. The lower surface 9a here comprises ribs 43, which during the flowing phase (dt2) are flowed out (50), resp., are completely filled, wherein here locally correspondingly sufficient flowable material has been inserted into the shell mold. FIG. 16b illustrates an example with geometrical shapings 42 in the form of holes or break-outs 44, which have been created during the flowing phase by a complete pressing together of the two shell molds 10a, 10b at this point 44, as well as thick layer zones 45, wherein the inserted material once again is locally correspondingly put together in order to completely flow out (50) the shapings. A metallic insert 28 at the edge of the cavity is able to be removed again following the production of the molded body, in order to form an undercut.

FIG. 17a illustrates two examples of additional, non-melting inserts, which can be integrated into a molded body: an additional surface layer 29, e.g., as a decorative layer or as fabric lamination, and an insert 28, which remains inside the molded body, here, e.g., in the form of a fixing element or a thread, by means of which it is possible to implement fixing devices or force introductions. For this purpose, here, the insert 28 is integrated into the molded body 1 with a locally increased proportion of layers reinforced with fibers 7.

The FIG. 17b illustrates that it is also possible to integrate further materials into the molded bodies in a simple manner, such as soft, elastic materials, e.g., temperature-resistant thermoplastic elastomers TPE, e.g., thermoplastic oligomers TPO, both as a surface layer or also in certain zones 26, which locally are capable of forming an elastic, soft area. It is also possible to form hollow bodies or hollow spaces 46, e.g., by means of internal gas pressure, with inflatable diaphragms or with inserted fill materials, e.g., in that a shaped, non-melting core is inserted, which after the pressing is able to be washed out again with water.

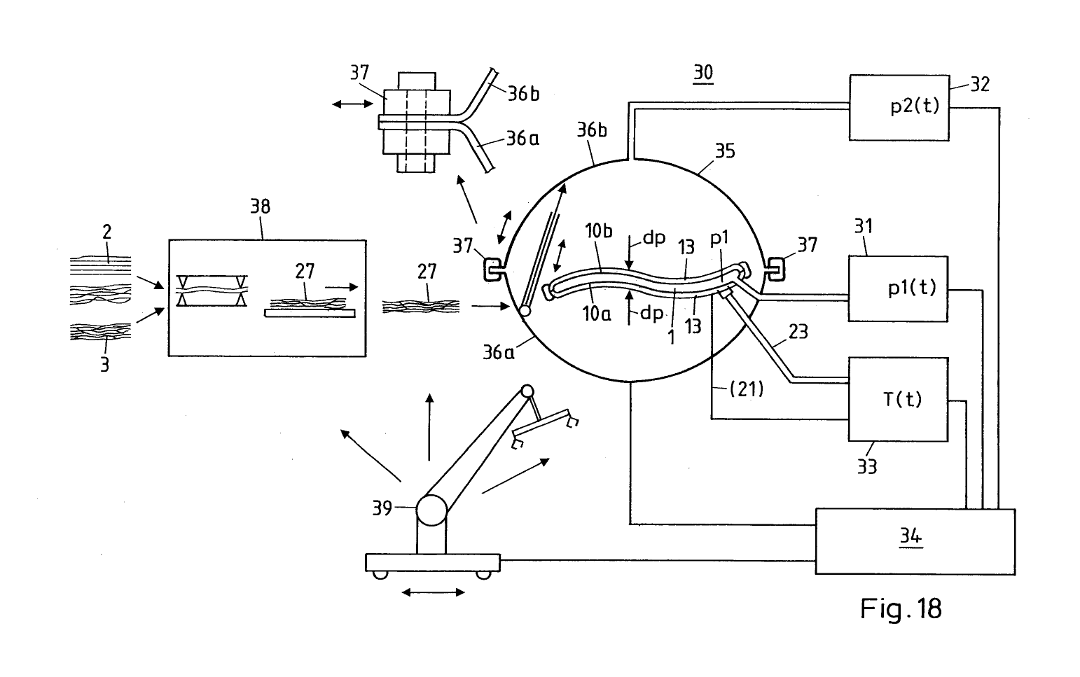

FIG. 18 illustrates an installation 30 for the implementation of the method according to the invention and with assigned further stations, by means of which an automated, series production of molded bodies reinforced with fibers is possible. The installation 30 comprises an upper and a lower shell mold 10a, 10b with tempering means 13, which are connected with a tempering device 33, e.g., with a power supply for the heating wires and with a cooling device for a liquid cooling medium 23, or also with a heating device and with a cooling device for a heating and a cooling liquid, which is able to be supplied alternatingly through the same channels 24, as well as a vacuum device 31 for the production of an under-pressure p1 and if so required an additional compressed air device 32 for the production of an external pressure p2 in a pressure chamber 35, which surrounds the shell molds 10a, 10b. It is possible to implement a controllable external pressure p2 in preference with compressed air of, e.g., 1 to 10 bar. A particularly light and strong pressure chamber 35 is, e.g., formed by two arched half-shells 36a, 36b out of continuous fiber-reinforced plastic material with a wall thickness of, e.g., 3-4 mm, which are capable of being opened and which comprise a frame with a locking device 37.

Assigned to the installation 30 is a confectioning station 38 for the cutting to size of different layers of materials made out of thermoplastic materials 2 and fiber reinforcements 3 and for the putting together of packs of material 27, which are also able to comprise further inserts. With a handling robot 39 it is possible to move materials for the putting together of packs of materials 27, for the positioned insertion into the shell molds 10 and for the unmolding. A process control system 34 controls the process parameters, i.e., the tempering temperature T(t), the pressure p(t) and the movements of materials.

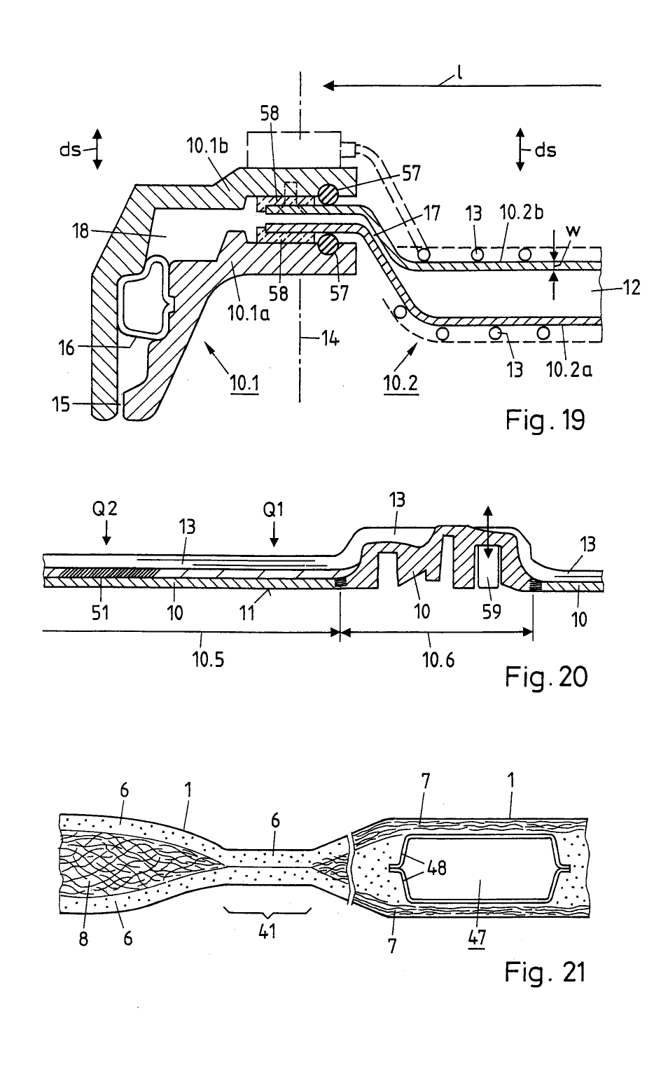

FIG. 19 illustrates an example of shell molds 10, which are designed to be able to be separated into two parts with an external edge part 10.1 and an internal mold part 10.2 forming the mold cavity 12. In this manner, it is possible to manufacture both parts separately and differently: the edge part 10.1, e.g. more rigid and with more complicated shapes for edge functions, guides, holding devices, connections, supply lines, etc. and the mold part 10.2 with simpler shapes is able to be executed, e.g., as galvanic, thin-walled and with this comprising a slight flexing elasticity. Thus, the mold part 10.2 is capable of being interchanged and it is possible to use different mold parts with one edge part 10.1 for the production of different molded bodies. This results in a cost saving for the tool manufacture. It is also solely necessary to heat and to cool the mold part 10.2 and not the edge part 10.1, so that the tempering is able to take place in a more simple manner, more rapidly and in a more energy saving way. For this purpose, the two parts 10.1 and 10.2 have to be connected together in a separatable manner, e.g., by bolting together, and in operation they have to be connected together vacuum-tight, e.g., with a seal 57, and they have to comprise a thermal insulation 58. In the edge part 10.1 the displacement compensating edge seal 16, the vacuum channels 18 and if so required also the centering portions 15, fixing and supply equipment are arranged. In the mold part 10.2 the tempering means 13, a retention zone 17 and if so required, also, centering portions 15 are arranged.

FIG. 20 illustrates further examples of locally differing shell molds, resp., temperings. On the left-hand side of FIG. 20, an example of locally differing tempering (Q1=more weakly tempered, Q2=more strongly tempered) is depicted, in the case of which the thermal contact, i.e., the heat transmission between the tempering means 13 (e.g., heating wires and cooling channels) and the shell mold 10 is designed to be stronger (51) or weaker in places. It is also possible that the metallic shell molds 10 are assembled out of several individual parts, resp., out of differing zones. Zones with a very complex shaping, e.g., with tight radii, edges or ribs, etc., e.g., are also capable of being milled or eroded out of a piece of metal (e.g., the mold part or the zone 10.6) and together with other mold parts (10.5) assembled to form a complete shell mold 10. In doing so, it is possible that the different mold parts are joined together, e.g., by soldering, welding or also by galvanizing together to form a complete shell mold. As complex shaping, e.g., an ejector 59 is able to be integrated into the shell mold in a vacuum-tight manner.

FIG. 21 Illustrates further examples of partial hollow body structures with defined air—or gas pockets in a molded body. On the left-hand side of FIG. 21, the molded body comprises an inner layer 8, which consists of a fleece with air pockets and external layers 6, which are completely consolidated. At defined points 41, e.g., at the edge of a component, it is possible that this layer structure is completely pressed together and compacted by correspondingly shaped shell molds 10. On the right in FIG. 21 a gas cushion 47 is arranged between structural layers reinforced with fibers 7. In doing so, a defined quantity of gas (air or an inert gas, such as nitrogen) is welded into a plastic foil 48 in a gas-tight manner for forming a gas cushion with a desired shape and position within the molded body or component 1. With partial hollow body structures of this kind it is possible, e.g., to produce particularly rigid and light components.

Within the scope of this description, the following designations are utilized:
1 Molded body
2 Thermoplastic material
3 Reinforcing fibers, semi finished products
4 Multilayered structure
6 Covering layers, external mold layers
7 Fiber-reinforced structural layers
8 Core layer, inner mold layer
9a, b Visible surfaces of 1
10 Shell molds
10.1 Edge part
10.2 Mold part
10a, b Lower, upper shell mold
11a, b Surfaces of 10
12 Mold cavity
13 Tempering means
14 Separating line of 10.1/10.2
15a, b Centered portion on 10
16 Edge sealing, edge seal
17 Retention zone
17a Contact points
17b Plunging edge
18 Vacuum channels
19 Insulation layer
21 Electric heating wires
23 Liquid cooling-/heating medium
24 Channels
26 Elastic materials
27 Packs of material
28 Insert
29 Additional surface layers
30 Installation
31 Vacuum device
32 Compressed air supply, —device
33 Tempering device
34 Control system
35 Pressure chamber
36a, b Half shells
37 Locking device
38 Confectioning station
39 Handling robot
41 Completely pressed
42 Geometrical shaping
43 Ribs
44 Holes, break-outs
45 Thick zones
46 Hollow bodies, hollow spaces
47 Gas cushion
48 Foils
50 Flowing out
51 Strong thermal contact
52 Recumbent shell
53 Support, support crimps
56 Inflatable
57 Seal
58 Thermal insulation
59 Ejector
t Time
dt Duration
dt1 Heating up
dt2 Flowing out, filling out
dt3 Cooling down
T, Ts, Te Temperatures
Tm Melting temperature, melting point
Tf Solidifying temperature
Tk Crystallization temperature zone
p Pressure
p1 Vacuum pressure
p2 External pressure, additional
dp Pressure difference
s Compression displacement
se Layer thickness of 1
ds Compression stages, displacement differences
Q1, Q2 Different temperings
w Thickness of the shell molds 10
l Length of 10, 12

1. A method for the production of molded bodies (1) out of thermoplastic material with or without fiber reinforcement in a one-step production process, comprising the steps of:
utilizing a tool with a lower and an upper shell mold (10a, 10b), which form a mold cavity (12) with surfaces defined on both sides (11a, 11b),
wherein the shell molds are designed as thin-walled and metallic,
with a centering portion (15a, 15b) of both the shell molds,
with a displacement compensating, air-tight edge seal (16) between the two shell molds,
and with tempering means (13) for the controllable heating and cooling of both shell molds (10a, 10b),
inserting thermoplastic material (2), with or without reinforcing fibers (3), into a shell mold in a locally defined manner,
closing the shell molds and subsequently evacuating (p1) and in doing so pressing together with a reduction (ds1) of the distance between the shell molds,
heating the shell molds up with the tempering means to a temperature above the melting point (Tm) of the thermoplastic material (2),
holding at a temperature (Ts) for the consolidation and flowing of the thermoplastic material under pressure (dp) with a further pressing together of the shell molds (ds2) up to the contour filling flowing out,
subsequently cooling down, under pressure, in a defined manner up to the complete solidification of the inserted material,
and opening the shell molds removing the formed molded body (1).

2. The method according to claim 1, wherein for the consolidation and flowing out, an additional external pressure (p2) is applied to the shell molds.

3. The method according to claim 2, wherein the external pressure (p2) is applied in a pressure chamber (35) by means of compressed air.

4. The method according to claim 1, wherein the shell molds, at the edge of the mold cavity, comprise a shaped retention zone (17) for the thermoplastic material.

5. The method according to claim 1, wherein, on the edge of the shell molds, vacuum channels (18) are conducted all around.

6. The method according to claim 1, wherein with the shell molds geometrical shapings (42) such as ribs (43), holes (44), break-outs and differing wall thicknesses (45) are produced.

7. The method according to claim 1, wherein the shell molds are designed as two parts and as separatable with a fixed edge part (10.1) and a mold part (10.2) forming the mold cavity (12).

8. The method according to claim 1, wherein the shell molds are comprised of differing zones (10.5, 10.6).

9. The method according to claim 1, wherein the metallic shell molds (10a, 10b) consist of galvanic layers of nickel and copper.

10. The method according to claim 1, wherein the tempering means are electrical and are attached to the shell molds in the form of insulated electric heating wires (21).

11. The method according to claim 1, wherein the tempering means comprises a liquid medium (23) that is utilized as cooling means or as heating means and cooling means, which circulates in channels (24) attached to the shell molds (10a, 10b).

12. The method according to claim 1, wherein the tempering means (13) are directly integrated into the shell molds (10).

13. The method according to claim 1, wherein on the shell molds, a locally differing tempering (Q1, Q2, 51) is produced.

14. The method according to claim 1, wherein the tempering during the cooling down step does not take place in a linear manner, but with a slower transition through certain temperature zones (Tk).

15. The method according to claim 1, wherein locally differing materials with differing characteristics and shapes are inserted into the shell molds in defined positions.

16. The method according to claim 1, wherein additional surface layers (29) are inserted into the shell molds.

17. The method according to claim 1, wherein on the surfaces or in certain zones soft, elastic materials (26) are inserted in a locally defined manner.

18. The method according to claim 1, wherein inserts (28) are inserted into the shell molds in a positioned manner, the inserts becoming integrated into the molded body or else are removed following the production.

19. The method according to claim 1, wherein hollow bodies or hollow spaces (46) are formed.

20. The method according to claim 1, wherein sealed gas cushions (41) with a defined gas content are inserted into the shell molds.

21. An installation (30) for the production of molded bodies out of thermoplastic material with or without fiber reinforcement in a one-step production process, comprising
a tool with a lower and an upper shell mold (10a, 10b), which form a mold cavity (12) with defined surfaces on both sides (11a, 11b),
the shell molds being thin-walled and metallic,
the two shell molds having a centering portion (15a, 15b),
a displacement compensating, air-tight edge seal (16) between the two shell molds,
a tempering means (13) for the controllable heating and cooling of both mold shells (10a, 10b), and
a vacuum device (31) and a control system (34),
wherein thermoplastic material (2) with or without reinforcing fibers (3) is able to be inserted into a mold shell in a locally defined manner,
wherein the shell molds are closable, allowing subsequent evacuation using the vacuum device (p1) and in doing so pressing together the shell molds with a reduction (ds1) of the distance between the shell molds,
wherein the shell molds are heatable, —with the tempering means, to a temperature above the melting point (Tm) of the thermoplastic material (2)
and wherein the tempering means are able to maintain the shell molds at a temperature (Ts) for the consolidation and flowing out of the thermoplastic material under pressure (dp) with a further pressing together of the shell molds (ds2) up to the contour-filling flowing out,
and wherein the shell molds are coolable under pressure in a defined manner with the tempering means, causing the complete solidification of the inserted material.

22. The installation according to claim 21, further comprising a compressed air device (32), for applying additional external pressure (p2) to the shell molds with compressed air.

23. The installation according to claim 21, further comprising two arched half shells (36a, 36b) made out of endless fiber-reinforced plastic material with a locking device (37), which form a pressure chamber (35).

24. The installation according to claim 21, further comprising an assigned confectioning station (38) for the cutting to size and putting together pack of material (27), a handling robot (39) for the positioned insertion of material and a process control system (34) for the controlling of the tempering, pressure and materials' movements.

25. A molded body made out of thermoplastic material, manufactured according to the method of claim 1, wherein shaped pore-free visible surfaces (9a, 9b) defined on both sides are produced.

26. The molded body according to claim 25, wherein the molded body has a multi-layered structure (4) or locally differing material compositions.
